(19) United States
(12) Patent Application Publication
(10) Pub. No.: US 2026/0160664 A1
(43) Pub. Date: Jun. 11, 2026

(54) COUPLED AERODYNAMIC AND OPTICAL SIZING OF AIRBORNE PARTICLES

(71) Applicant: Aerosol Dynamics, Inc., Berkeley, CA (US)

(72) Inventors: Stavros AMANATIDIS, Berkeley, CA (US); Susanne Vera HERING, Berkeley, CA (US)

(21) Appl. No.: 19/408,572

(22) Filed: Dec. 4, 2025

Related U.S. Application Data
(60) Provisional application No. 63/729,369, filed on Dec. 7, 2024.

(51) Int. Cl. G01N 15/1434; G01F 13/00; G01N 15/00; G01N 15/10; G01N 15/14; G01N 15/1409

(52) U.S. Cl. CPC G01N 15/1434; G01F 13/006; G01N 15/1012; G01N 15/1409; G01N 2015/0046; G01N 2015/1014; G01N 2015/1024; G01N 2015/1027; G01N 2015/1029; G01N 2015/1452; G01N 2015/1493

(57) ABSTRACT

A method and apparatus for aerodynamic sizing of particles are disclosed. An airflow containing particles is introduced into an inlet at or near atmospheric pressure and passed through a focusing acceleration nozzle. The nozzle rapidly accelerates the flow at an exit into a measurement chamber. A light beam is focused near the nozzle exit, and a detector measures light scattered by particles passing through the beam. A signal measurement device determines the transit time of individual particles crossing the light beam based on the scattered light pulse signals. A processor records these transit times and determines a count of particles and an effective air sample volume. The system outputs a particle aerodynamic size distribution by correlating the measured transit time to aerodynamic diameter using calibration standards.

### CLAIM OF PRIORITY

This application is a claims priority to U.S. Provisional Patent Application No. 63/729,369 filed Dec. 7, 2024, by Stavros Amanatidis and Susanne Hering titled, “Coupled Aerodynamic and Optical Sizing for Airborne Particles,” which is incorporated by reference herein in its entirety.

### GOVERNMENT LICENSE RIGHTS

This technology was made with government support under Grant DE-SC0024851 from the US Department of Energy. The government has certain rights in the technology.

### TECHNICAL FIELD

The disclosed technology pertains to the measurement of particles suspended in air or other gas, including a means to size particles in a size range from about 1 μm to 20 μm in diameter.

### BACKGROUND

Coarse airborne particles, roughly 1-10 μm in diameter, are of concern due to public health, and to the environment more generally. Concentrations, especially in urban areas, vary geographically and temporally, presenting a monitoring challenge. Optically based sensors have gained attention due to their relatively low cost that provides accessibility to users and researchers, but optical sizing does not relate to physical size in a consistent manner. Optical sizing may depend on the particle refractive index, which is generally not known. This dependency can introduce significant measurement error in particle sizing, and consequently to the reported suspended mass. Variation in the environmental conditions further affects accuracy. Needed is a more accurate yet affordable means of real-time monitoring of these coarse particles. Aerodynamic sizing, which is independent of particle refractive index but incorporates the particle material density is an attractive option. One limitation is the complexity and cost of existing aerodynamic sizing instruments.

### SUMMARY

This Summary is provided to introduce a selection of concepts in a simplified form that are further described below in the Written Description. This Summary is not intended to identify key features or essential features of the claimed subject matter, nor is it intended to be used as an aid in determining the scope of the claimed subject matter.

One general aspect includes a method for aerodynamic sizing of particles. The method includes introducing an airflow containing particles into an inlet, the airflow being at or near atmospheric pressure. The method also includes passing the airflow through a focusing acceleration nozzle, the nozzle having an axial length, the nozzle having a output orifice sized to rapidly accelerate the flow at an exit of the acceleration nozzle. The method also includes directing a single light beam focused near the exit of the focusing acceleration nozzle within a measurement chamber surrounding the exit of the focusing acceleration nozzle having. The method also includes detecting light scattered from individual particles passing through the collimated light beam. The method also includes measuring the elapsed time between two points in the light scattering signal from the passing of a single particle through the light beam to provide a transit time for each detected particle. The method also includes recording the transit time of individual particles crossing the light beam to provide a count of particles at each transit time over a measurement interval. The method also includes determining an effective air sample volume during the measurement interval from the flow rate of the airflow and the duration of the measurement interval. The method also includes outputting a particle aerodynamic size distribution from the count of particles at each transit time divided by the effective air sampling volume, where the aerodynamic diameter is determined from the transit time through calibration.

Implementations may include the above method wherein the focusing acceleration nozzle has one or more radial contractions along the axial length. Implementations may include any of the above methods wherein the transit time is characterized by the full width at half maxima defined as the time between the point when the signal rises to one half of its maximum value until it drops to one half of its maximum value. Implementations may include any of the above methods wherein the transit time is characterized by the time between the point when the signal attains its maximum until it drops to one half of its maximum value. Implementations may include any of the above methods wherein the transit time is characterized by the time between the point when the signal reaches its maximum until it drops to a fixed fraction of its maximum value Implementations may include any of the above methods wherein the transit time is characterized by the time between the two fixed fractions of the maximum in the light scattering signal. Implementations may include any of the above methods wherein the method further includes recording a height of an individual light scattering pulse, the height defined as the maximum in the light scattering signal from an individual particle. Implementations may include any of the above methods wherein the method further includes simultaneously measuring optical and aerodynamic size, and the simultaneous measurement of optical and aerodynamic size is used to distinguish among particle types. Implementations may include any of the above methods wherein the method further includes calibrating the height of individual to an optical size of the particle. Implementations may include any of the above methods wherein the method includes calibrating includes using polystyrene latex spheres to relate the height of individual to an optical size of the particle. Implementations may include any of the above methods wherein the method further includes analyzing the shape of the pulse to identify erroneous signals that may arise from coincident or stray particles. Implementations may include any of the above methods wherein the erroneous signals are excluded from the particle count. Implementations may include any of the above methods wherein the mass of suspended coarse particulate matter over the measurement size range is estimated based on aerodynamic size distribution. Implementations may include any of the above methods wherein the transit time is characterized by the time between two points of fixed signal strength.

One general aspect includes an apparatus for aerodynamic sizing of particles. The apparatus includes an inlet coupled to receive an airflow containing particles at or near atmospheric pressure. The apparatus also includes a measurement chamber. The apparatus also includes a focusing acceleration nozzle coupled to the inlet, the nozzle having an axial length, the nozzle having a output orifice sized to rapidly accelerate the flow at an exit of the acceleration nozzle into the measurement chamber. The apparatus also includes a laser emitting a light beam focused at the exit of the focusing acceleration nozzle. The apparatus also includes a detector detecting light scattered from particles passing through the light beam to provide a pulse signal of magnitude versus time. The apparatus also includes a processor and memory, the processor including code instructing the processor to: record a transit time of individual particles crossing the collimated light beam, and to output an aerodynamic diameter from the transit time based on calibration with particle standards of known size and density. Other embodiments of this aspect include corresponding computer systems, apparatus, and computer programs recorded on one or more computer storage devices, each configured to perform the actions of the methods.

Implementations may include one or more of the following features. The apparatus where the focusing acceleration nozzle has one or more radial contractions along the axial length. Implementations may include an apparatus wherein the length of the final orifice is less than one half of the nozzle diameter. Implementations may include an apparatus wherein the distance between the nozzle exit and the collimated light beam is less than about 1 millimeter. Implementations may include recording the maximum peak height in the scattering signal from particles passing through the light beam, and correlating this signal with the transit time.

### BRIEF DESCRIPTION OF THE DRAWINGS

FIG. 1A is a schematic diagram of an instrument for measuring particle sizes in accordance with the disclosed embodiments.

FIG. 1B is an graph showing an example of a light scattering pulse observed when a particle passes through the light beam.

FIG. 1C is graph illustrating an example of a light scattering pulse observed when two particles pass through the light beam together.

FIG. 2 is a cross-sectional, mechanical drawing of an example embodiment of a portion of the device illustrated schematically in FIG. 1.

FIG. 3A is a cross-section of one embodiment of the focusing acceleration nozzle of the disclosed technology, referred to herein as “long”.

FIG. 3B is a cross-section of another embodiment of the focusing acceleration nozzle of the disclosed technology, referred to as a “short”.

FIG. 3C is a cross-section of another embodiment of the focusing acceleration nozzle of the disclosed technology, referred to as “elongated”.

FIG. 3D is a cross-section of another embodiment of the focusing acceleration nozzle of the described technology, referred to as “short-step”.

FIG. 4A shows modeled air flow streamlines obtained by numerical modeling for the elongated focusing acceleration nozzle of FIG. 3C (only half or which is shown) operated at a flow rate of 1.0 L/min.

FIG. 4B shows the trajectories of 1 μm particles obtained by numerical modeling for the elongated focusing acceleration nozzle of FIG. 3C (only half or which is shown) operated at a flow rate of 1.0 L/min.

FIG. 4C shows the trajectories of 5 μm particles obtained by numerical modeling for the elongated focusing acceleration nozzle of FIG. 3C (only half or which is shown) operated at a flow rate of 1.0 L/min.

FIG. 4D shows the trajectories of 10 μm particles obtained by numerical modeling for the elongated focusing acceleration nozzle of FIG. 3C (only half or which is shown) operated at a flow rate of 1.0 L/min.

FIG. 5 is a graph of the modeled particle velocity as a function of the axial position along the centerline of the nozzle for the elongated focusing acceleration nozzle of FIG. 3C for a flow rate of 1.0 L/min.

FIG. 6 is a graph of the modeled particle velocities at a distance 0.6 mm downstream of the exit of the elongated focusing acceleration nozzle of FIG. 3C as a function of the radial position for particles of varying aerodynamic diameter at a flow rate of 1.0 L/min.

FIG. 7 is a histogram of the time-of-flight normalized with respect to the flow velocity at a distance 0.6 mm downstream of the exit of the elongated focusing acceleration nozzle when operated at a flow rate of 1 L/min.

FIG. 8 is a graph of the modeled time-of-flight for the elongated acceleration nozzle of FIG. 3C at 0.6 mm downstream of the nozzle exit verses the aerodynamic diameter for operation at various flow rates.

FIG. 9A is a histogram of the time-of-flight normalized with respect to the flow velocity at a distance 0.6 mm downstream of the exit of the long focusing acceleration nozzle when operated at an air flow rate of 1.5 L/min.

FIG. 9B is a histogram of the time-of-flight normalized with respect to the flow velocity at a distance 0.6 mm downstream of the exit of the short focusing acceleration nozzle when operated at an air flow rate of 1.5 L/min.

FIG. 10A is a graph of the transmission through a single step of the focusing acceleration nozzle as a function of a transmission Stokes number.

FIG. 10B is a graph showing the dependence of the particle trajectories on a focusing Stokes number.

FIG. 11 is a schematic of an experimental setup used to evaluate the system performance.

FIG. 12 is a display of light scattering pulses measured with an aero-optical sizer system disclosed herein utilizing a short focusing acceleration nozzle.

FIG. 13A is a histogram showing the distribution in the light scattering pulse widths (FWHM) measured with the aero-optical sizer system for four sizes of polystyrene latex aerosol.

FIG. 13B is a histogram showing the distribution in the light scattering pulse widths (FWHM) measured with the aero-optical sizer system for two sizes of borosilicate glass spheres.

FIG. 14 is a graph of the pulse width (FWHM) as a function of aerodynamic diameter measured with the aero-optical sizer system at various flow rates for polystyrene latex and borosilicate glass test particles, and the theoretical values obtained by modeling.

FIG. 15A compares parallel measurements of the aerodynamic size distribution of 2.9 μm polystyrene latex aerosol from the aero-optical sizer system to that from the TSI Aerodynamic Particle Sizer, where the dashed lines show nominal particle aerodynamic size.

FIG. 15B compares parallel measurements of the aerodynamic size distribution of 8.3 μm polystyrene latex aerosol from the aero-optical sizer system to that from the TSI Aerodynamic Particle Sizer, where the dashed lines show nominal particle aerodynamic size.

FIG. 15C compares parallel measurements of the aerodynamic size distribution of borosilicate glass aerosol with a nominal aerodynamic diameter of 4.0 μm.

FIG. 15D compares parallel measurements of the aerodynamic size distribution of borosilicate glass aerosol with a nominal aerodynamic diameter of 13 μm.

FIG. 16 is a graph of optical diameter versus the aerodynamic diameter for polystyrene latex and borosilicate glass spheres measured by the aero-optical sizer system.

FIG. 17 is a graph of the light scattering pulse width at 70% of the peak maximum versus its width at 50% of the maximum.

FIG. 18 is a flowchart illustrating a method in accordance with the disclosed technology.

### WRITTEN DESCRIPTION

The disclosed technology sizes airborne particles based on their aerodynamic behavior in an accelerating air flow, thereby providing aerodynamic particle size. The disclosed technology also captures the optical response as they pass through a laser beam, yielding an optical size for each individual, aerodynamically sized particle.

The disclosed technology comprises a compact instrument to size airborne coarse particles aerodynamically, while retaining optical response. Aerodynamic sizing characterizes particle motion in an airflow when the air velocity changes. The optical response, or optical size, refers to the light scattered by the particle. The disclosed technology captures both an aerodynamic size and the optical response of individual particles suspended in a gaseous medium. The disclosed technology may be used in the characterization of particles in ambient air, whether in the atmosphere or in an indoor or industrial space. The target particle size range is 1 μm to 20 μm.

For a smooth, spherical particle, the aerodynamic size depends on the density of the material of which the particle is composed. The estimate of suspended particle mass derived from aerodynamic sizing has only an inverse square root dependence on the assumed particle density, while suspended mass derived from optical scattering depends directly on density as well as the assumed refractive index. Thus, aerodynamic sizing provides a better means to monitor the suspended particulate mass over the spanned size range.

The measurement of both optical and aerodynamic sizing can be used to distinguish between different types of particles. With both pieces of information on a single particle basis, a soil dust particle such as silica, with a refractive index of 1.45 and a density of 2.65 g/cm³, could be distinguished from a pollen or organic matter, with a similar refractive index and a density near 1.0 g/cm³. These particles have similar optical characteristics but quite different aerodynamic diameters. This ‘double-size spectroscopy’ can aid in distinguishing different classes of coarse particulate matter, such as those associated with soil dust particulate matter, as compared with pollens of the same geometric size, but lower density.

Aerodynamic size is defined as the diameter of a smooth, spherical particle that exhibits the same aerodynamic behavior as the subject particle. For a spherical particle, the particle aerodynamic diameter is related to its physical diameter by the relationship:

$${D}_{ae} = {D}_{p} \sqrt{\frac{C}{{C}_{ae}} \frac{ρ}{{ρ}_{0}}} \qquad equation [ 1 ]$$

where Dₐₑ is the aerodynamic-equivalent diameter, Dₚ is the physical particle diameter, ρ is the particle material density, ρ₀=1.0 g/cm³, and C and Cₐₑ are the Cunningham slip factor evaluated at the physical and aerodynamic diameters, respectively. Based on the above, the ratio between the mass of a particle calculated based on the aerodynamic diameter mₐₑ to that based on the physical diameter mₚ is

$$\frac{{m}_{ae}}{{m}_{p}} = \frac{\frac{π}{6} {ρ}_{0} {D}_{ae}^{3}}{\frac{π}{6} ρ {D}_{p}^{3}} = {( \frac{C}{{C}_{ae}} )}^{3 / 2} {( \frac{ρ}{{ρ}_{0}} )}^{1 / 2} \qquad equation [ 2 ]$$

The ratio C/Cₐₑ is close to 1 for particles larger than 1 μm. For approximately spherical particles, its mass can be estimated within an error dependent on the square root of the assumed particle material density. Setting C/Cₐₑ=1, the total mass of suspended particulate matter M over a size range from Dₚ=D₁ to D₂₂ approximated by the integral over the size distribution:

$$M = \frac{π}{6} {( \frac{{ρ}_{O}}{ρ} )}^{1 / 2} {\int }_{{D}_{1}}^{{D}_{2}} {D}_{ae}^{3} \frac{dN}{d log {D}_{p}} d log {D}_{p} \qquad equation [ 3 ]$$

Aerodynamic diameter is important for coarse particles, that is those larger than about 1 μm. In this size range, aerodynamic diameter is a governing parameter for transport and deposition. Additionally, particle size distributions based on aerodynamic diameter are useful in estimating mass distributions, as described above. While not a mass measurement, it is much closer than that which can be obtained with optical sizing alone, which relies on assumptions regarding both particle density and refractive index.

An established means of characterizing particle aerodynamic size is to sharply accelerate a particle-laden air flow through an acceleration nozzle, and to measure the velocity of individual particles as they exit the nozzle. The larger particles, which have greater inertia as compared to their aerodynamic drag, cannot follow the rapidly accelerating flow, and their velocity lags that of the airflow. The aerodynamic diameter is determined by measuring the particle velocity at the nozzle exit. The smaller particles more closely follow the air flow acceleration and have a higher velocity at the nozzle exit than do the larger particles.

Aerodynamic sizing is used in a several aerosol mass spectrometers, such as those described by John Jayne et al (Aerosol Science and Technolology, 33:49-70, 2000.), by M. Johston and A. Wexler (Anal. Chem. 67: 721A-726A, 1995), by D. Murphy and D. Thomson (Aerosol Sci. Technol. 22:237-249, 1995) and C. Noble, and K. Prather. (Environ. Sci. Technol. 30:2667-2680, 1996). It was also used in the particle beam apparatuses of B. Dahneke and H. Flachsbart, (J. Aerosol. Sci. 3:345-349, 1972) and U.S. Pat. No. 3,854,321. In each of these systems particles are injected into the vacuum chamber through a small orifice, creating a beam of particles within the chamber. The air rapidly accelerates as it passes through the orifice into the vacuum chamber, and particles reach a velocity that is dependent upon their aerodynamic size. Due to the vacuum level pressures of these systems, particles retain the velocity at which they exit the orifice as they transit the downstream vacuum chamber. This gives ample space for determination of the particle velocity, which is then related to the particle aerodynamic size.

Aerodynamic sizing at ambient pressures is more of a challenge than at the near-vacuum pressures found in these particle beam and aerosol mass spectrometry systems. The concept is similar wherein a particle laden flow is directed through a nozzle, and aerodynamic size is determined by the velocity of particles near the exit of the nozzle. Two limitations arise for aerodynamic sizing at atmospheric pressure. First, due to viscous drag, the airstream velocities near the edge of the nozzle are lower than at the center, and thus airflow acceleration is not uniform across the nozzle. Secondly, at atmospheric pressures the presence of the carrier gas in the region downstream of the acceleration nozzle enables particles to rapidly regain the velocity of the carrier gas, either within the nozzle, or at a very short distance downstream. Thus, when the chamber downstream of the acceleration nozzle is close to atmospheric pressure, the particle velocity measurement must be made close to the point of maximum acceleration.

One instrument that measures particle aerodynamic size at ambient pressures is described by: U.S. Pat. No. 5,561,515, and further detailed by P. Baron, Aerosol Science and Technology, 5:55-67, 1986; and Wang and John, Aerosol Science and Technology, 6:5191-198, 1987. This instrument has been available commercially for several decades through TSI Inc. as the Model 3321 Aerodynamic Particle Sizer. This TSI instrument uses a filtered sheath flow to confine particles to the center portion of the flow within an acceleration nozzle, thereby subjecting all particles to a uniformly accelerating airflow. The particle velocity is measured immediately downstream of the nozzle exit by the time-of-flight between two closely spaced maxima within a double crested light beam. This double crested beam is actually two, closely spaced overlapping laser beams formed using a birefringent crystal. This instrument provides precise particle sizing, with a quoted resolution of a few percent at 10 μm. However, it is much too costly to serve the needs for ambient air monitoring.

The described technology provides a simpler approach for aerodynamic sizing at ambient pressures which eliminates the sheath flow and eliminates the double-crested laser beam of the TSI Model 3321. In place of the sheath flow, the disclosed technology utilizes aerodynamic focusing to nudge particles to the center of the flow prior to the acceleration step. In place of the dual, or double-crested laser, this disclosed technology characterizes the particle velocity at the nozzle exit by the transit time of the particle across a single light beam, as characterized by the pulse width at half maximum. Further, it identifies coincidence arising from the presence of two or more particles in the detection region by analysis of the shape of the scattered light pulse. This disclosed technology also retains the amplitude of the optical scattering signal for each particle, yielding two types of sizing: aerodynamic and optical, for each particle. In recognition of this double sizing capability, the disclosed technology is referred to as the “aero-optical sizer”.

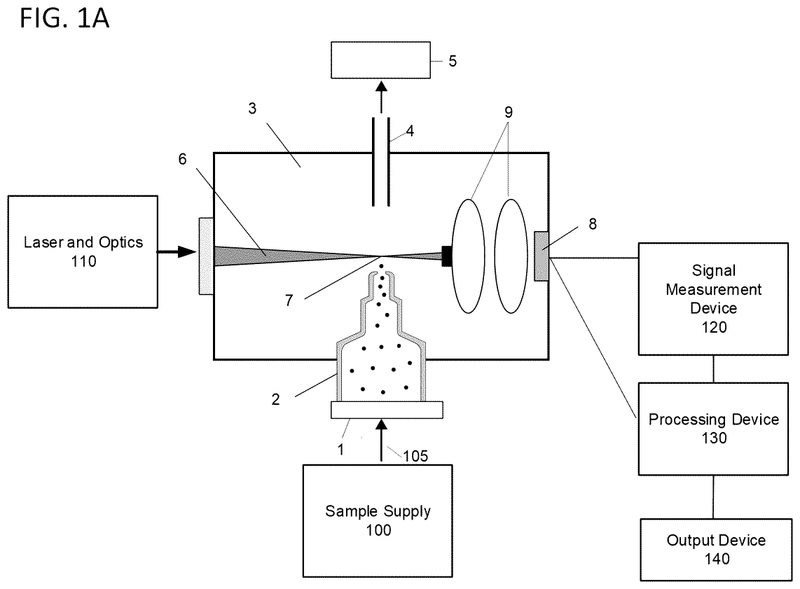

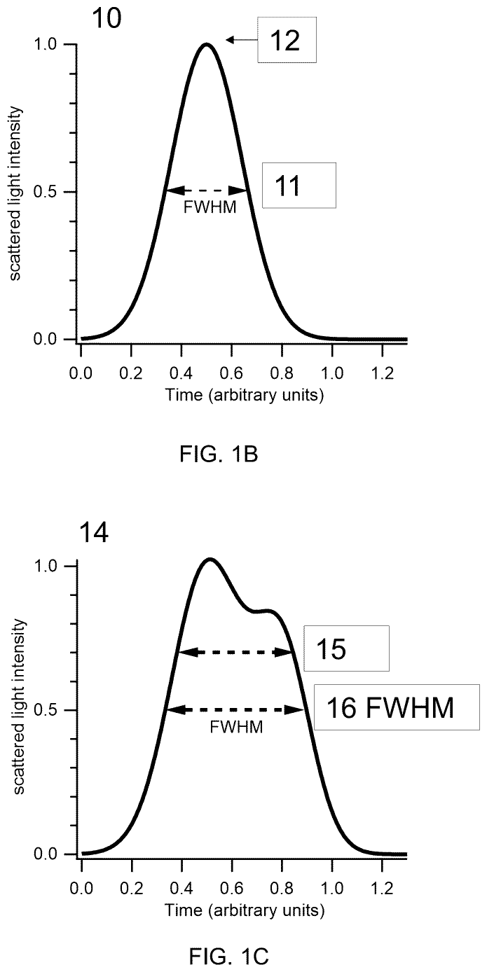

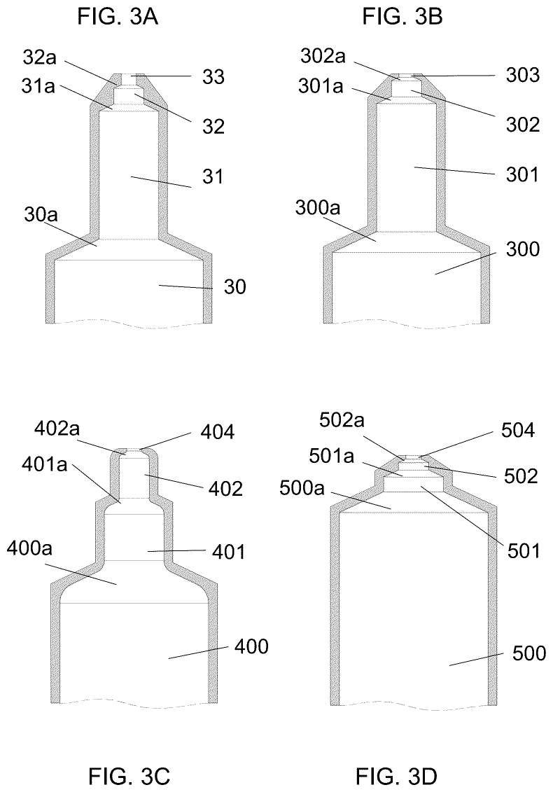

FIG. 1A is a schematic of an aero-optical sizer apparatus of the disclosed technology. A sample supply 100 is operatively coupled to an inlet 1. Particles suspended in an air flow 105 are introduced at an inlet 1 through a focusing acceleration nozzle 2 into a detection chamber (or measurement chamber) 3. This focusing acceleration nozzle 2 has several steps in the inner profile (described further with respect to FIGS. 3A-3D) that nudge the larger particles towards the center of the airflow. The exit of the nozzle is sufficiently small to sharply accelerate the flow. A laser or other collimated light source 110 provides an optical beam 6 which is focused to a point 7 near the exit of the nozzle 2. Flow exits through a port 4 and directed to air mover 5 and is controlled to a selected air flow rate. Individual particles suspended in the air scatter light from the incident light beam 6 as they transit through the beam 6 at point 7. A portion of this light is directed via optics 9 comprising lenses or mirrors onto a photodetector 8. The output of the photodetector provides a pulse signal of magnitude versus time for every individual particle that is detected. A signal measurement device 120 can be used to measure the elapsed time between two points in the pulse signal to determine a transit time of the particle across the light beam. A signal measurement device 120 is optional in some embodiments. The signal measurement device may also record the elapsed time between a second pair of points in the magnitude of the pulse signal to determine the shape of the pulse signal. Optionally, the signal measurement device may record the maximum magnitude of the pulse signal. A processing device 130, including memory and a processor (such as a central processing unit or a programmable microprocessor), may be used in some embodiments to analyze the pulse signal and provides an output to an optional output device 140. The processing device 140 collects particle counts over a measurement interval, identifies valid counts based on pulse shape, accumulates the valid counts in multiple bins based on the measured transit time. The aerodynamic size corresponding to each transit time bin is determined by calibration with particles of known size and density. Typically, the output device 140—outputs aerodynamic particle size distribution calculated as the number of valid particles in each aerodynamic size bin divided by the effective volume of sampled air, normalized by the width of the size bin.

Each particle passing through the light beam at point 7 produces a light scattering pulse 10. This light scattering pulse 10 is approximately Gaussian in shape, as shown in FIG. 1B. The particle velocity at point 7 is determined by the transit time across the light beam. This may be characterized by the full width at half maximum (FWHM) defined as the time 11 that the signal is greater than one-half of its maximum value 12. Alternatively, it could be characterized by the time from the maximum to one-half of the maximum, or between any two points scaled to the peak maximum, or between two fixed values of the signal strength. Through calibration with particle standards comprised of particles of known size and material density the transit time is related to the particle aerodynamic diameter. The transit time can also be related to particle aerodynamic diameter through modeling The optical response is characterized by the peak height, defined as the maximum 12 in the amplitude of the light scattering pulse 10. Through calibration with monodispersed polystyrene latex spheres (PSL) of various sizes an ‘optical’ or PSL-equivalent particle size is obtained.

When two or more particles pass through the detection region at the same time, the light scattering pulse is “fattened” or double-crested. This is referred to as coincidence. For accurate sizing, the signal from coincident particles must be excluded from analysis. FIG. 1C is an example of the light scattering pulse from coincident particles. In contrast to the pulses from a single particle transiting the light beam, the light scattering pulse shown in FIG. 1C is not Gaussian.

Analysis of the shape of this pulse 14 provides a means of identifying coincidence. One approach for identifying signals resulting from coincidence is to calculate the ratio of the peak width at two different points as compared to that expected for a Gaussian peak. For example, referencing FIG. 1C, the ratio of the width 15 of the observed peak at 70% of the maximum peak width to that at 50% of the peak height 16 is compared to the value for Gaussian pulse. For Gaussian shaped signals this ratio has a fixed value of 0.71, regardless of the standard deviation or height of the signal. For the coincident peak this ratio may be either larger or smaller. Alternatively, one can assess whether the signal is symmetric, as indicated by whether the rise time from the baseline, or a fixed value above the baseline to the maximum equals the time required for the signal to return to this value. Within expected measurement uncertainties, these ratios can be used to determine whether the peak shape has the Gaussian, or near-Gaussian shape that characterizes the signal from a single particle, and thus whether it should be included in particle size distribution measurement.

As is commonly done in particle counting measurements, such as optical particle counters or condensation particle counters, the data can be corrected for dead time. Dead time refers to that time in which the signal is above the baseline, and therefore an incoming particle cannot be detected. The effective volume of sampled air is calculated as the flow rate multiplied by the quantity of the elapsed time minus dead time.

While aerodynamic sizing is a well-established technique, the disclosed technology offers several new and unique features. Particles are focused along the centerline of the flow by means of a series of steps that gently nudge the larger particles toward the centerline of the flow prior to the creation of the rapid acceleration, thereby eliminating the need for a sheath flow. To facilitate the sizing of smaller particles, the length of the final nozzle step is short, typically a fraction of the nozzle diameter at the final step. The particle velocity is determined by the transit time of the particle across a single, collimated light or laser beam, enabling the velocity measurement within a short distance of the nozzle exit. The transit time is characterized by the elapsed time between two defined points in the magnitude of the light scattering pulse For example, it may be characterized by the width of the light scattering pulse at half its maximum height. The presence of coincidence, that is the simultaneous occurrence of two or more particles within the detection region, is evaluated by examining the shape of the light scattering pulse. Still further, the height of the light scattering pulse is captured to simultaneously characterize the optical-equivalent particle size. This yields two pieces of information on each particle—aerodynamic size and an optical-equivalent size. The disclosed technology is specifically designed to accommodate measurements near ambient pressure, between about 700 mbar to 1100 mbar.

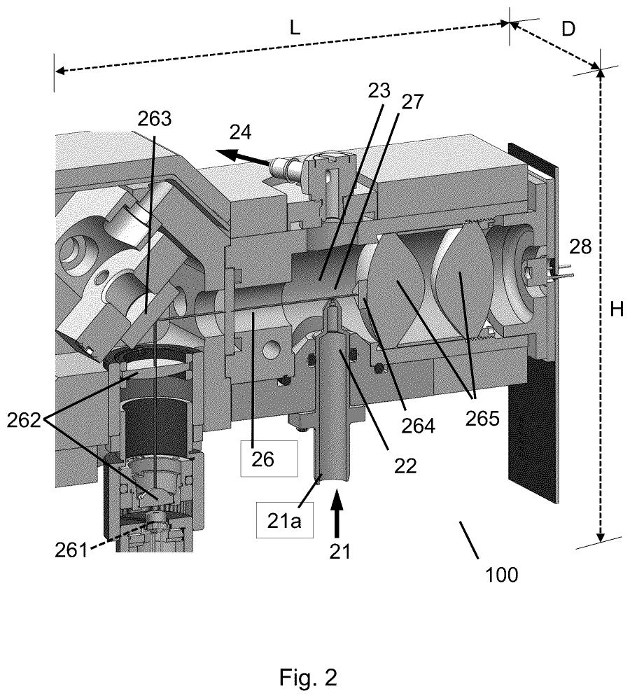

FIG. 2 is a mechanical drawing of a portion of one embodiment of the aero-optical sizer apparatus 100 in accordance with the described technology. Overall dimensions are 12 cm (L)×12 cm (H)×8 cm (D), excluding the air mover and control board. The apparatus 100 may operate at a flow rate of 0.25-1.5 L/min and has a target particle size range of 1-10 μm. Referencing FIG. 2, particle-laden air stream 21 enters at inlet 21A (reference 1 in FIG. 1) through an focusing acceleration nozzle 22 (reference 2 in FIG. 1), into the detection chamber 23 (reference 3 in FIG. 1) and exits through port 24 (reference 4 in FIG. 1). A light beam 26 (reference 6 in FIG. 1) is directed across the exit of nozzle 22, to a beam stop 264 (part of reference 9 in FIG. 1). The intersection of the particles exiting the nozzle 22 and the light beam 26 forms the detection region 27 (reference 7 in FIG. 1). Light scattered in the forward direction by particles within the detection region 27 is focused via lenses 265 (part of reference 9 in FIG. 1) onto a photo detector 28 (reference 8 in FIG. 1). The embodiment shown is one embodiment and comprises the embodiment that was used for experimental evaluation, as described below. Other optical configurations may be used. In the implementation shown, the laser beam is formed by means of laser diode 261 and lenses 262, and directed across the nozzle 22 via steering mirror 263. Alternatively, a laser diode and focusing lenses can be mounted on-axis, eliminating the steering mirror. In yet another implementation, the photo detector 28 can be mounted at right angles to the laser beam to collect side-scattered light. An elliptical or cylindrical mirror mounted opposite the detector may be used to focus side scattered light from over a wide range of angles onto the detector.

FIGS. 3A-3D show section views of several embodiments of the focusing acceleration nozzle 22 of the disclosed technology. FIG. 3A is a cross-section of one embodiment of the focusing acceleration nozzle of the disclosed technology, referred to herein as “long”. FIG. 3B is a cross-section of another embodiment of the focusing acceleration nozzle of the disclosed technology, referred to as a “short”. FIG. 3C is a cross-section of another embodiment of the focusing acceleration nozzle of the disclosed technology, referred to as “elongated”. FIG. 3D is a cross-section of another embodiment of the focusing acceleration nozzle of the disclosed technology, referred to as “short-steps”.

These nozzles consist of a series of cylindrical tubes (e.g. sections 30, 31, 32) of successive smaller diameters connected by steps (e.g. 30a, 31a) and by a final orifice (e.g. 33 connected to tube 31a by step 32a). In FIG. 3a the focusing acceleration nozzle consists of an inlet tube 30, and pair of smaller tubes 31 and 32 connected by respective steps 30a and 31a followed by final orifice 33 connected to tube 31a by step 32a. Analogously, in FIG. 3B the focusing acceleration nozzle has inlet tube 300 is connected to cylindrical tubes 301 by step 300a, with tube 301 connected to tube 302 by step 301a, and tube 302 connected to orifice 303 by step 302a. The elongated and short step embodiments of FIGS. 3C and 3D are similarly constructed of tubes 400-402, 500-502, steps 400a-402a, 500a-502a, and orifices 404, 504, respectively. Aerodynamic focusing is provided by the focusing “steps” that are the transition between the tubes. At each step the nozzle diameter is sharply reduced, thereby generating a radially inwards flow momentum which drives particles closer to the centerline. Multiple steps are used to achieve gradual focusing from larger to smaller particle diameters, which minimizes particle losses at each step due to impaction. The final nozzle (orifice) diameter at the nozzle exit generates a rapid flow acceleration to produce the aerodynamic sizing effect.

The nozzle of FIG. 3A is similar to that described by Vidal-de-Miguel and Fernandez de la Mora (Aerosol Science and Technology, vol. 46 pp 287-296, 2012, hereinafter “Vidal”) and by Zervaki, Dionysiou and Kulkarni (Journal of Aerosol Science, vol 174, p. 106235, 2023, hereinafter “Zervaki”), as well as by Hering et al (U.S. Pat. No. 8,459,572). These investigators aimed to focus particles spanning a wide range of sizes onto a single point downstream of the nozzle exit. As described by Vidal, the focal point is approximately 1 nozzle diameter. Correspondingly, their nozzle designs employ steps in which the axial length and diameter of each step are similar. In the focusing nozzle of Zervaki, the axial length of each focusing step is even larger relative to its diameter.

The objective of the focusing acceleration nozzle of the technology described herein is somewhat different. The aim is to concentrate the particles over a range of sizes into the center core of the flow, to then accelerate them rapidly, and to deliver the particles to near the center of the optical chamber for measurement. Initially, the nozzle design of FIG. 3A, referred to as “long” was evaluated. This has a long throat to introduce particles close to the center of the optical chamber, followed by additional focusing steps and by a final acceleration step. The initial stage provides the length to reach into the optical detection chamber, the subsequent steps provide particle focusing, and the final step provides both focusing and the rapid acceleration necessary for aerodynamic sizing. In the initial design shown in FIG. 3A, the length of the final orifice 33 was three-quarters of its diameter. It was determined both experimentally and in modeling that the length of the final nozzle made it difficult to capture the particle velocity immediately after the point of acceleration. The design of FIG. 3B, referred to as “short”, was also evaluated. The only change was to shorten the final orifice 303 as much as was physically practical. In this design the length of the final orifice 303 is one-quarter that of its diameter. FIG. 3C shows yet another design, referred to as “elongated” in which the axial lengths of the tubes 31 have been lengthened to allow for a smaller outer diameter at its tip where the flow exits, which is advantageous for reducing stray light scattering in the measurement chamber. FIG. 3D shows yet another design, referred to as “short-steps” in which the axial lengths of the tubes 31 have been shortened to allow for easy manufacturability of the final steps.

Table 1 lists critical dimensions for each of the four nozzle designs of these embodiments. Each consists of an inlet tube, followed by a first step to a cylindrical “Tube 1” then a second step to a cylindrical “Tube 2” and finally to a final orifice. The transitions between the tubes comprise the “steps” of the aerodynamic focusing. The design of FIG. 3A is referred to as “long” due to its relatively long final throat of the final orifice. The design of FIG. 3B is referred to as “short”, as the only change from the “long” design was to shorten the final orifice 303. The design of FIG. 3C is referred to as “elongated” due to the lengthening of the axial lengths of each step. The design of FIG. 3D is referred to as “short steps” as the tube lengths in the short-steps design of FIG. 3D are shortened to approximately one-quarter of its diameter. In all cases the transition between these straight-walled step sections are a cone of included solid angle of 130°, which matches that of a drill point. The elongated design was explored because it the outer diameter at its tip can be small and thereby cause less stray light scattering. The potential advantage of the short-steps design is that its focusing tip may be separately fabricated, using for example, additive machining techniques. Alternative designs are possible, such as with additional steps or rounded transitions. The transitions can be rounded, which reduces recirculation zones and particle losses, as described by Vidal.

TABLE 1
Dimensions of Three Designs of the Focusing Acceleration Nozzle

| Design | Focusing Step | Length (mm)¹ | Diameter (mm) |
|---|---|---|---|
| Long | Inlet Tube | ~25 | 5.0 |
| (FIG. 3A) | Tube 1 | 4.32 | 2.0 |
| | Tube 2 | 0.53 | 1.0 |
| | Final orifice | 0.38 | 0.5 |
| Short | Inlet Tube | ~25 | 2.0 |
| (FIG. 3B) | Tube 1 | 4.32 | 2.0 |
| | Tube 2 | 0.53 | 1.0 |
| | Final orifice | 0.13 | 0.5 |
| Elongated | Inlet Tube | ~26 | 5.0 |
| (FIG. 3C) | Step 1 | 2.0 | 2.0 |
| | Step 2 | 1.5 | 1.0 |
| | Final orifice | 0.13 | 0.50 |
| Short-steps | Inlet Tube | ~30 | 5.0 |
| (FIG. 3D) | Step 1 | 0.50 | 2.0 |
| | Step 2 | 0.25 | 1.0 |
| | Final orifice | 0.13 | 0.50 |
| Transition between | 130° angle | | |
| tubes - all cases | | | |

¹does not include the length of the portion with tapered walls (e.g. steps 30a, 31a, etc.) that transition to the next step

These focusing acceleration nozzle designs were guided by finite element modeling to optimize the aerodynamic focusing and aerodynamic sizing in the 1-10 μm range. Modeling was done in COMSOL Multiphysics® software using a two dimensional, axisymmetric geometry. The model first solves the steady-state flow field in the nozzle geometry, which is then used to calculate the resulting particle trajectories. Modeling was done at over a range of flows between 0.25-1.50 L/min for each of the above nozzle designs, and for particles with 0.5-10 μm aerodynamic diameter.

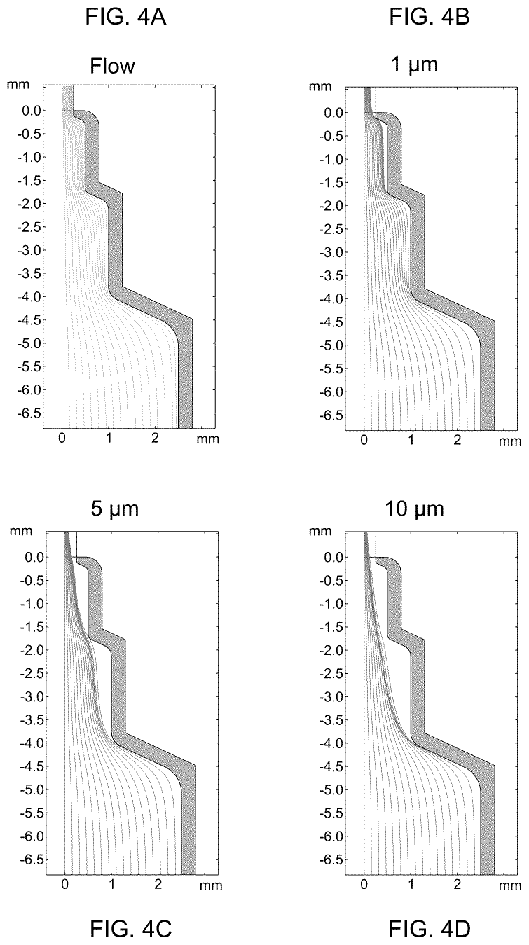

FIGS. 4A-4D show the modeled flow and particle trajectories through the focusing steps of the “elongated” focusing-acceleration nozzle of FIG. 3C when operated at a flow rate of 1.0 L/min. FIG. 4A shows the air flow streamlines obtained FIG. 4B, FIG. 4C and FIG. 4D show respectively the trajectories of 1 μm, 5 μm and 10 μm particles. Trajectories for 10 μm particles begin to focus as they pass through the first focusing step and further along their path until the nozzle outlet. Particles with smaller inertia are more difficult to focus, as they require more abrupt changes in flow velocity to separate their motion from the flow streamlines. Particles with diameters of 5 μm move towards the center such that the majority are contained within a well-defined region. At the first step this region is within about 75% of the diameter of first Tube 401, while at the second step the particles become yet more concentrated, moving to within 50% of the diameter of the second tube 402. For 1 μm particles minimal focusing occurs in the first step, but the subsequent steps enable focusing for those comparatively smaller inertia particles.

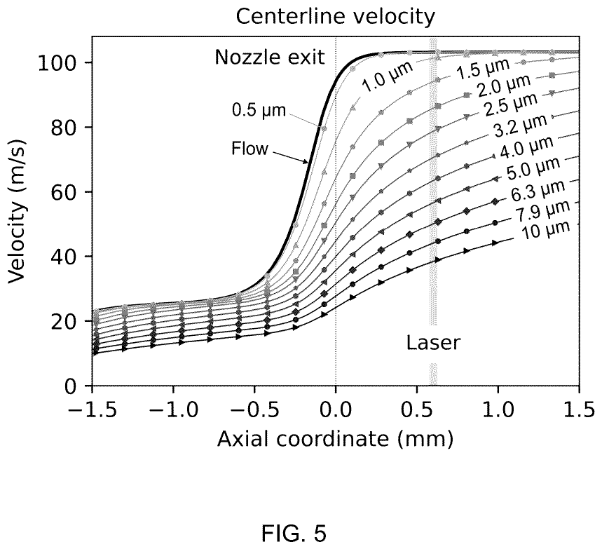

Aerodynamic sizing in the focusing-acceleration nozzle is realized by rapidly accelerating the flow just before the nozzle outlet. FIG. 5 is a graph of the modeled particle velocity as a function of the axial position along the centerline of the nozzle for the elongated focusing acceleration nozzle of FIG. 3C for a flow rate of 1.0 L/min. Just before the final orifice, within the distance of 1 milimeter (mm), the flow velocity increases by about a factor of four. Depending on their aerodynamic size, particles acquire different exit velocities, with larger particles experiencing more lag, and therefore lower velocity, than smaller particles. The largest difference in particle velocities is very near the nozzle exit, where the acceleration is largest. Once the particles exit the nozzle they begin to regain the velocity of the airflow.

Ideally one would want to determine the particle velocity at the nozzle exit, but practical constraints due to background light scattering off the tip of the nozzle limit how close to the nozzle exit measurements can be made. Experimentally it is possible to make measurements within 0.6 mm of the nozzle exit.

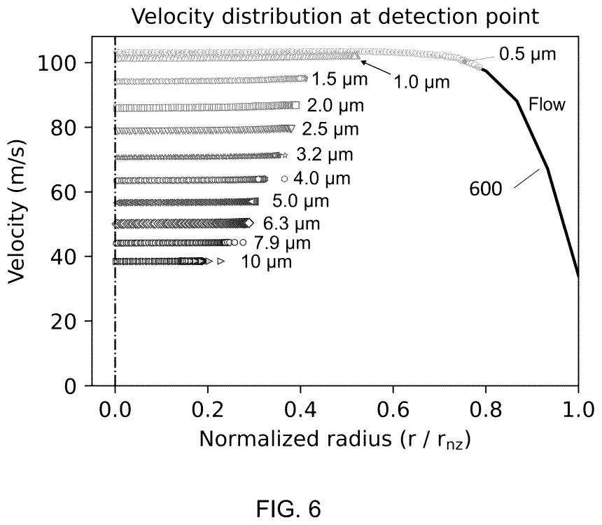

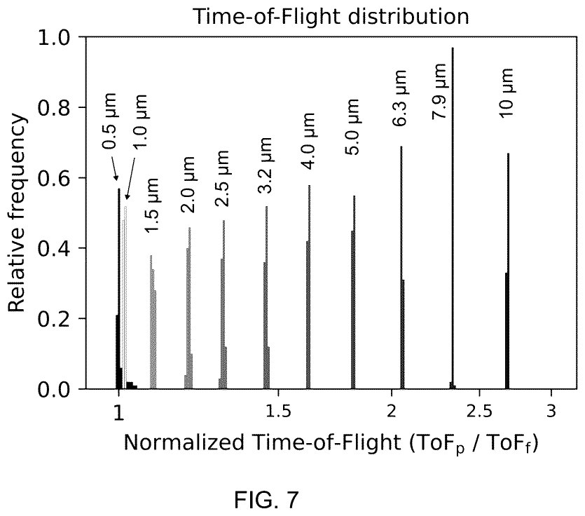

FIG. 6 is a graph of the modeled particle velocities at a distance 0.6 mm downstream of the exit of the elongated focusing acceleration nozzle of FIG. 3C. Results are shown as a function of the radial position for particles of varying aerodynamic diameter at a flow rate of 1.0 L/min. The zero x-coordinate represents the nozzle center. The solid black line 600 shows the predicted flow velocity distribution. At inner radial positions this line is hidden behind the points for the 0.5 μm trajectory. Particle velocities are indicated by individual points. Each point represents a single particle out of a total one hundred particles simulated per particle size. These points are concentrated near the centerline due to focusing. Except for the 0.5 μm particles, which follow closely the flow velocity trace, particle velocities are nearly independent of the radial position, but are a strong function of the particle size. FIG. 7 displays this same result as a histogram, wherein the particle velocities are converted into time-of-flight normalized by the time of flight at the flow velocity. The resulting distribution at each particle size is very narrow, with clearly distinguishable peaks.

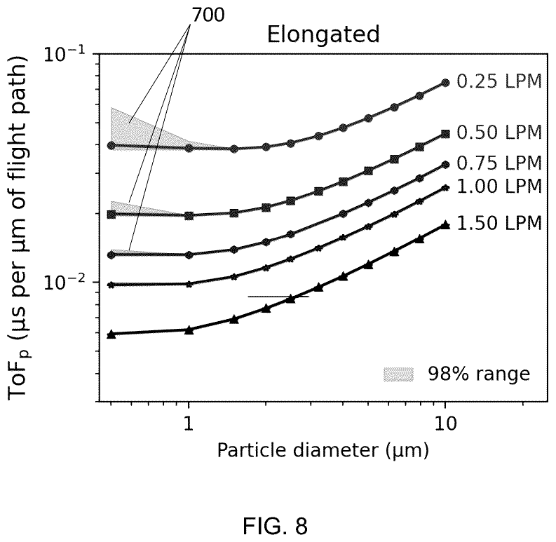

FIG. 8 summarizes all of the modeling results for the elongated focusing acceleration nozzle of FIG. 3C. Shown, as a function of particle aerodynamic diameter, is the particle time of flight across of the particles at a measurement point located 0.6 mm downstream of the nozzle exit. The time of flight expressed as us per μm of flight path length. Each line is for a separate air flow rate. The shaded regions 700 indicate the spread in the particle velocities at each size, where 98% of the particles lie within the shaded area. At a flow rate of 1 L/min the time of flight across a 40 μm flight path ranges from 0.32 us for 1 μm particles to 0.9 μs for 10 μm particles. Particles larger than 1.5 μm are readily separated from those that are smaller. At lower flow rates the time of flight is longer, ranging from 1-1.6 μs at 0.5 L/min flow, but the resolution below about 2 μm aerodynamic diameter is poorer.

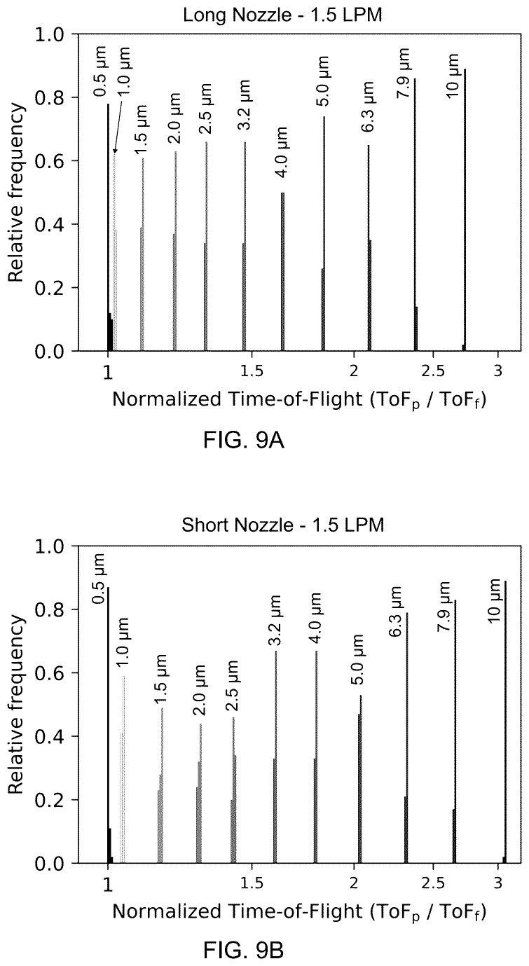

The calculations enumerated above were also performed for each of the other designs presented in FIGS. 3A-3D and Table 1. FIGS. 9A and 9B compare results for the long and short nozzle designs. FIG. 9A is a histogram of the time-of-flight normalized with respect to the flow velocity at a distance 0.6 mm downstream of the exit of the long focusing acceleration nozzle when operated at an air flow rate of 1.5 L/min. It should be noted that the histograms for the smallest particles, with diameters of 0.5 μm and 1.0 μm overlap. Thus, it is not possible to distinguish these particle sizes. FIG. 9B presents the corresponding histogram for the short nozzle. In contrast, for the short nozzle, illustrated in FIG. 9B, the traces for 0.50 μm and 1.0 μm are now clearly separated. Recall that the only difference in these two nozzle designs is the length of the final orifice. These histograms illustrate the advantage of the shorter final orifice. Flow modeling shows that with a shorter final orifice the flow at the centerline continues to accelerate downstream of the nozzle exit, while with the longer nozzle the centerline flow reaches its terminal velocity within the nozzle. As the distance from the nozzle exit at which the particles can be viewed is constrained by practical manufacturing limitations, the shorter final orifice allows the user to probe closer to the point of final acceleration. The elongated and short-steps designs both utilize this short final orifice, and have histograms very similar to those of the short nozzle shown in FIG. 9B.

In accordance with the modeling, each of the four focusing acceleration nozzle designs focuses particles from 1 μm to 10 μm along the center portion of the flow and subsequently subject these focused particles to an equal acceleration. The resulting particle velocity at the exit of the nozzle depends on the particle aerodynamic size, independent of their initial radial position in the flow. The three designs utilizing a short final orifice, herein referred to as “short”, “elongated” and “short-step” are found to have very similar performance. Each provides better separation among the smallest particles than with the more conventional focusing design of prior work that use a longer final orifice. The “elongated” design offers the practical advantage that the outside diameter of the nozzle within 1 mm of its exit can be as small as 2 mm, reducing the potential for stray light scattering within the detection chamber. The “short-steps” design confines the focusing region to a very short distance, that may be advantageous for manufacturing.

Embodiments other than those shown are possible. Alternative designs include those with additional steps or more rounded transitions, or with a different angle at the transition. The governing parameter is the ratio in the diameters between successive tubes. To a lesser extent the performance is affected by the length of each tube and the angle of the transition. Rounded corners reduce the formation of recirculation zones, can delay the onset of turbulence at high flows, as well as reduce particle losses.

The focusing and the depositional loss within each step of the focusing acceleration nozzle is governed by a particle Stokes number. Generally, the Stokes number is defined as the ratio of the particle relaxation time to a characteristic time. Alternatively, the Stokes number can be thought of as the ratio between the particle stopping distance and a characteristic distance. The equation defining the Stokes number is:

$$St = \frac{τ U}{D} \qquad [ equation 4 ]$$

where U is a particle or airstream velocity, D is the characteristic distance, and τ is the relaxation time of the particle. The relaxation time equals ρDₚ²C/(18μ) where Dₚ is the physical diameter of the particle, C is the Cunningham slip factor, ρ is the particle material density and μ is the air viscosity. The particle stopping distance is the distance a particle moving with a velocity U would travel if injected into a still gas, and is equal to τU.

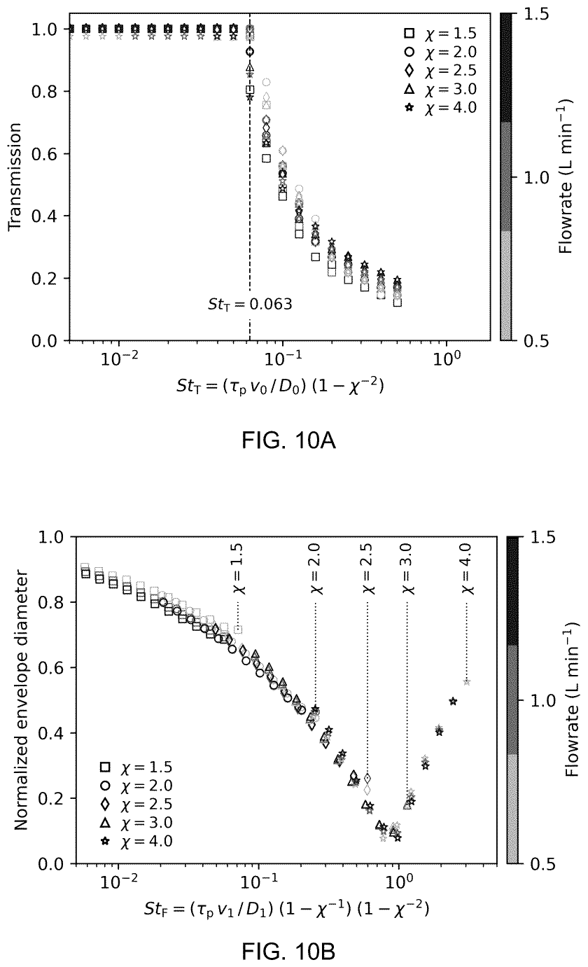

Through computer modeling, it has been determined that there is an ideal range in the ratio of the diameters of the successive tubes that define the focusing steps. The transmission and focusing was modeled over a wide range in flow rates and geometries. Turning first to the particle transmission at the first focusing step, with reference to FIG. 3C, the transmission efficiency was evaluated between a first tube 300 of diameter Dₒ and the first focusing tube 301 of diameter D₁. We find that the transmission is dependent on a transmission Stokes number St_{T}=(τu/D₀)(1−χ⁻²) where x is the diameter ratio defined as χ=D₀/D₁. The functional form of this dependency reflects the ratio in the particle relaxation time τ and a transit time for the inwardly directed flow from D₀ to D₁. As shown in FIG. 10A, the transmission efficiency is at or close to 100% when the transmission Stokes number St_{T}<0.06. For a particle size of 10 μm, when operating at a flow rate of 1 L/min, this corresponds to a diameter ratio D₀/D₁ of about 2.5.

Within the first focusing stage, particles are directed radially inward. The extent of this inward direction is dependent on the focusing stage Stokes number St_{F1}=τU₁D₁(1−χ⁻¹)(1−χ⁻²). Those particles with St_{F1}>1 will “over-focus”, crossing the centerline of the flow, while those with St_{F1}<0.01 will be displaced by less than 15% from the flow streamlines. Those particles of intermediate values of St_{F1} move towards the center of the flow such that the majority are found within a diameter Dᵢ. This Dᵢ that defines the envelope within which the majority of the particles are found is readily apparent in the particle streamline trajectories shown in FIG. 4C. Modeling shows that Dᵢ depends on St_{F1} as illustrated in FIG. 10B. Particles focus closest to the centerline for St_{F}=1. At small χ particles are lost before they reach this point, in accordance with the relationship for Str plotted in FIG. 10A. The dotted lines in FIG. 10B indicates the largest value for Str that may be reached for each value of χ prior to the onset of particle loss. The transmission efficiency to the subsequent focusing tube of diameter D₂ (tube 401 of FIG. 3C) depends on both St₁ and Dᵢ. For Dᵢ<D₂ the particles have already reached the radius of the downstream tube and the transmission efficiency is 100%. For Dᵢ<D₂ the focusing stage Stokes number St_{F1} must be small enough to avoid deposition. Modeling shows that the optimal focusing without particle loss is obtained at a diameter ratio between the two focusing stages between 1.5 and 3, ie 1.5<D₁/D₂<3.

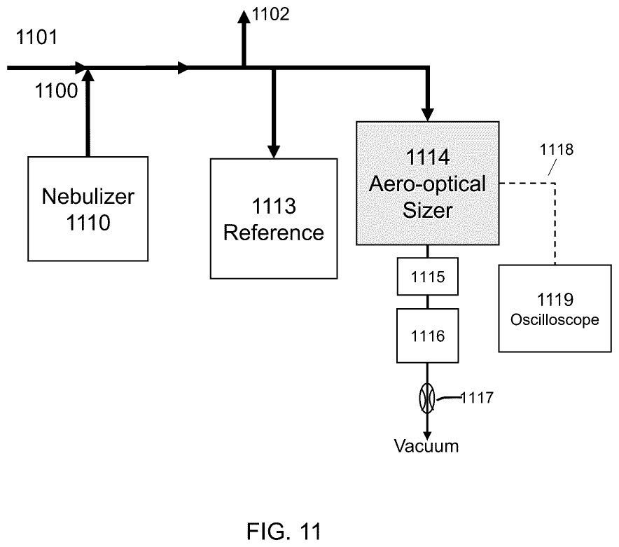

Laboratory evaluations of an embodiment of the aero-optical sizer shown in FIG. 2 were conducted. The instrument response was evaluated using near-monodispersed polystyrene latex spheres, and borosilicate glass spheres. These data were obtained using the short focusing acceleration nozzle sketched in FIG. 3B. A block diagram of the experimental setup is shown in FIG. 11. Test aerosols in the 1.4-8.2 μm size range were generated by nebulizer 1110. The nebulizer output 1100 of 1-2 L/min was mixed with 5-15 L/min of dry air 1101 and sampled by the aero-optical system 1114 of the disclosed technology and by aerodynamic particle size reference instrument 1113. Excess flow 1102 was directed through a vent. The reference instrument 1113 is an Aerodynamic Particle Sizer Model 3321 manufactured by TSI Inc, and is based on U.S. Pat. No. 5,561,515. The aero-optical flowrate was controlled by downstream orifice 1117 and monitored by flow meter 1116. A filter 1115 preceded the flow meter. The light scattering signal 1118 from the photodetector was captured by an external computer-based oscilloscope 1119 (Picoscope Model 3205D). Experiments were conducted at several flow rates in the range of 0.25-1.5 L/min. At each flow rate and particle size the oscilloscope was programmed to collect one thousand pulses that were saved for post-processing.

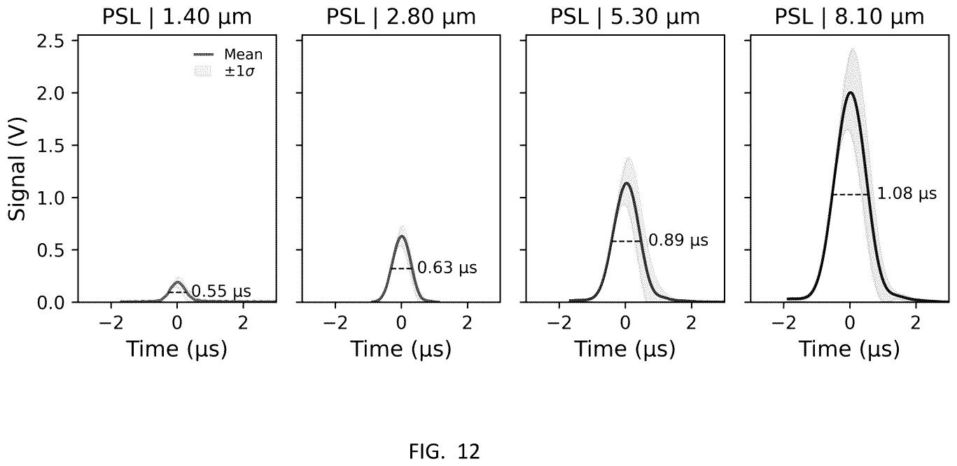

FIG. 12 is a display of light scattering pulses measured with an aero-optical sizer system as disclosed herein utilizing a short focusing acceleration nozzle. FIG. 12 shows data obtained at four sizes of monodispersed polystyrene latex sphere for a constant flow rate of 1 L/min. The velocity of the particles exiting the focusing acceleration nozzle was probed with a single laser beam estimated to be 0.6-0.7 mm downstream of the nozzle exit. Each particle passing through the laser beam generates a light scattering pulse that is detected by the photodetector and captured by the computer-based oscilloscope 1119. At each of the four particle sizes the solid line indicates the mean of the approximately one thousand pulses measured, while the shaded area shows one standard deviation from that mean.

Three aspects of this signal are important to the measurements of the aero-optical sizer of this disclosed technology: the pulse width the pulse height and the pulse shape. The pulse width, or duration, is the measure of the particle velocity, from which the particle aerodynamic diameter is determined. The pulse height yields an optical, or PSL-equivalent size, just as in the commonly used optical particle counters. The pulse shape is used to identify coincidence and false events that must be excluded from the sizing analysis.

The transit time of the particle through the single laser beam is the measure of the particle time-of-flight. This can be characterized by the full width of the pulse at half-maximum (FWHM). Other characterizations are possible. Possible alternatives are the time from the peak maximum to one-half of that maximum, or to some other fixed fraction of the peak maximum, or between two fixed values of the signal strength. For the experimental data presented here we have used the FWHM.

FIG. 12 is a display of light scattering pulses measured with an aero-optical sizer system disclosed herein utilizing a short focusing acceleration nozzle.—FIG. 12 indicates the value of the FWHM for each of the particle size measured. As the width of the laser beam is fixed, the FWHM is inversely proportional to the particle velocity at the point of measurement. As the larger particles move more slowly, the transit time and value of the FWHM increases with increasing particle size. Specifically, for the polystyrene latex particle data shown, the transit time is 0.55 μs at 1.40 μm particle size, to 0.63 μs at 2.80 μm, then to 0.89 μs at 5.30 μm, and finally to 1.08 μs at 8.10 μm. The increase in transit time with particle size, and hence longer FWHM, is a measure of the velocity lag of the larger particles that results from the accelerating flow of the focusing-acceleration nozzle. In turn, this lag is a measure of the particle aerodynamic behavior, or its aerodynamic diameter.

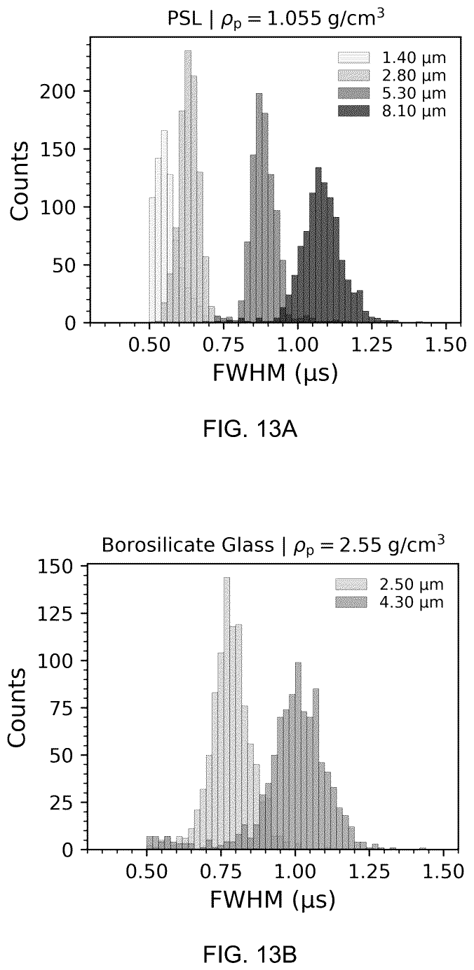

FIG. 13A is a histogram showing the distribution in the light scattering pulse widths (FWHM) measured with the aero-optical sizer system for four sizes of polystyrene latex aerosol. FIG. 13B is a histogram showing the distribution in the light scattering pulse widths (FWHM) measured with the aero-optical sizer system for two sizes of borosilicate glass spheres. FIGS. 13A and 13B are histogram distributions of the FWHM based on the measured pulses at each input particle size. Data obtained with polystyrene latex aerosol, which has a material density of 1.055 g/cm³ (shown in FIG. 13A), and with borosilicate glass spheres which have a material density of 2.55 g/cm³ (shown in FIG. 13B). Generally, the spread will depend on the distribution of the aerosol, as well as the performance of the aerodynamic focusing and sizing. These test aerosols were nominally monodispersed, that is each aerosol was of a uniform size. The spread in the measured FWHM transit time is generally less at the larger particle sizes.

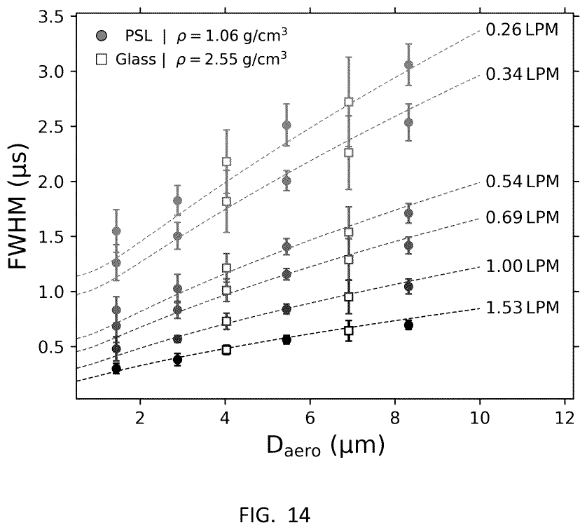

FIG. 14 is a graph of the pulse width (FWHM) as a function of aerodynamic diameter measured with the aero-optical sizer system at various flow rates for polystyrene latex and borosilicate glass test particles, and the theoretical values obtained by modeling. FIG. 14 displays the measured FWHM as a function of aerodynamic particle size over a range of flow rates. Data is included for monodispersed polystyrene latex spheres, shown as filled circles, and for near-monodispersed borosilicate glass particles, shown as open squares. Measurements were made at six flow rates, ranging from 0.26 L/min to 1.53 L/min. The aerodynamic diameter for these tests aerosols is calculated from the nominal physical particle size, as stated by the manufacturer, and the material density, in accordance with equation [1]. Dashed lines show COMSOL model predictions for the short nozzle geometry.

The experimental observations are in reasonably good agreement with model prediction. Overall, the pulse FWHM, a proxy for particle time-of-flight, increases with increasing aerodynamic particle size and decreasing flowrate. Note that the data for the borosilicate glass, with a material density of 2.55 g/cm³ fall on a common curve as for polystyrene latex, with a material density of 1.055 g/cm³. Importantly, a consistent aerodynamic response at each flowrate with sampled particles of significantly different material density has been observed, as borosilicate glass spheres are nominally ˜2.4 times denser than PSL. This results in a significant difference between the particle aerodynamic diameter for the same physical size. That both types of particles fall on a common curve confirms our aerodynamic particle sizing approach.

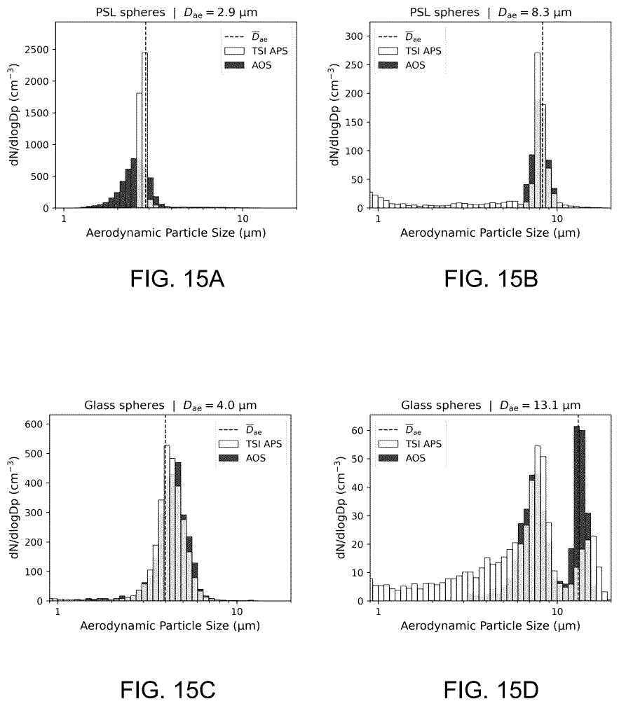

FIGS. 15A-15D are example comparisons in the aerodynamic particle size distribution obtained with this disclosed technology to concurrent size distribution measurements from the TSI Model 3321 Aerodynamic Particle Sizer that served as reference. Both instruments bin particle counts by the particle aerodynamic diameter Dₚ. The aerodynamic size distribution is calculated as the number concentration dN within each size bin normalized by the width of that size bin, d log Dₚ. FIG. 15A compares parallel measurements of the aerodynamic size distribution of 2.9 μm polystyrene latex aerosol from the aero-optical sizer system disclosed herein to that from the TSI Aerodynamic Particle Sizer, where the dashed lines show nominal particle aerodynamic size. FIG. 15B compares parallel measurements of the aerodynamic size distribution of 8.3 μm polystyrene latex aerosol from the aero-optical sizer system to that from the TSI Aerodynamic Particle Sizer, where the dashed lines show nominal particle aerodynamic size. FIG. 15C compares parallel measurements of the aerodynamic size distribution of borosilicate glass aerosol with a nominal aerodynamic diameter of 4.0 μm. FIG. 15D compares parallel measurements of the aerodynamic size distribution of borosilicate glass aerosol with a nominal aerodynamic diameter of 13 μm.

Data from the aero-optical sizer disclosed herein are compiled based on the calibration curves shown in FIG. 14. By measurement of the pulse width (FWHM), and using an appropriate calibration curve, each detected particle pulse can be binned into a size distribution measurement. The vertical dashed line indicates the nominal aerodynamic diameter of the test aerosol. In general, good agreement is shown between the aero-optical sizer disclosed herein and the reference TSI Model 3321. For polystyrene latex particle sizes of 2.9 μm (top left panel), the reported distribution is much broader, indicating poorer precision at these small sizes. At the larger, 8.3 μm polystene latex particles (top right panel) and the 4.0 μm aerodynamic diameter glass spheres, the aero-optical sizer is in good agreement with the reference both in terms of distribution peak location and width. For the 13.1 μm borosilicate glass spheres both instruments report a bimodal distribution, indicating fragmentation of the test aerosol.

Table 2 lists the modal parameters of the size distributions reported by the present prototype embodiment of this disclosed technology and the TSI reference instrument for all particle types and sizes tested. Modal parameters include the number-weighted mean particle size μ, the standard deviation of the distribution σ, and the ratio of the standard deviation to the mean, σ/μ. The table does not include the largest glass particle aerosol due to its bimodal distribution. The mean size reported by the disclosed technology agrees within 3.3% on average against the TSI reference instrument. Maximum differences are of the order of 9% at the smallest aerodynamic sizes. In terms of precision, the TSI Model 3321 reference instrument has a consistent relative standard deviation (σ/μ) of ˜4.6% across all polystyrene latex sizes. The corresponding range with the aero-optical sizer disclosed herein is ˜9% at the larger PSL sizes (5.3 and 8.1 μm), and drops with decreasing size to 17% (2.8 μm) and 41% (1.4 μm).

TABLE 2
Modal parameters of PSL and Glass aerosol distributions

| | | | | | | | Aero-optical Sizer | | |
|---|---|---|---|---|---|---|---|---|---|
| | | | | TSI Reference | | | (this technology) | | |
| | Density | D̅ₚ | D̅ₐₑᵣₒ | Mean, μ | σ | | Mean μ | σ | |
| Aerosol | (g/cm³) | (μm) | (μm) | (μm) | (μm) | σ/μ | (μm) | (μm) | σ/μ |
| PSL | 1.055 | 1.40 | 1.44 | 1.51 | 0.07 | 0.046 | 1.38 | 0.56 | 0.406 |
| | | 2.80 | 2.88 | 2.76 | 0.11 | 0.040 | 2.53 | 0.42 | 0.166 |
| | | 5.30 | 5.45 | 5.72 | 0.25 | 0.044 | 5.62 | 0.48 | 0.085 |
| | | 8.10 | 8.32 | 7.96 | 0.43 | 0.054 | 8.00 | 0.74 | 0.093 |
| Glass | 2.55 | 2.50 | 4.04 | 4.25 | 0.66 | 0.155 | 4.39 | 0.74 | 0.169 |
| | | 4.00 | 6.91 | 7.62 | 0.88 | 0.115 | 7.23 | 0.98 | 0.136 |

Ordinary optical particle counters size particles optically based on the height, or maximum amplitude, of the light scattering pulse produced when a particle transits a laser beam. This signal is used to report a particle optical size, which is defined as the size of a polystyrene latex particle that produces the same pulse height when passing through the laser beam. Optical size depends on the refractive index of the material of which the particle is comprised, and to a lesser extent on the configuration of the optical detector. It is independent of particle material density. As with an ordinary optical particle counter, the peak height from each light scattering pulse gives the particle optical size, as determined by calibration with polystyrene latex aerosols.

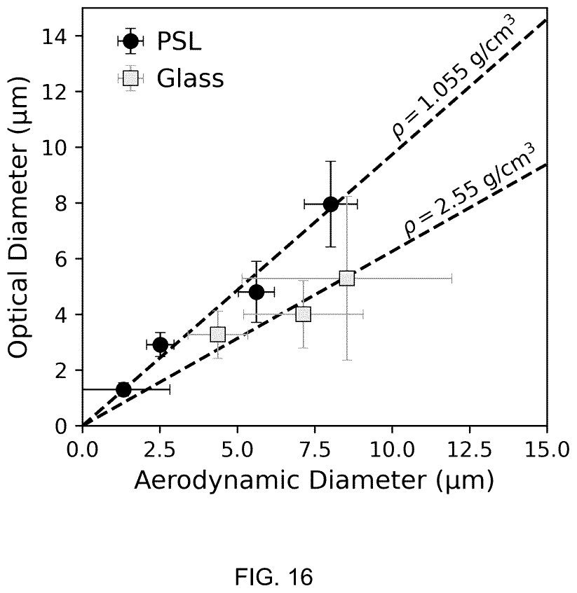

FIG. 16 summarizes the concurrent optical and aerodynamic diameter for individual particles measured in the above testing. For each type and size of particle tested with the aero-optical sizer of this disclosure, the measured optical diameter is plotted against the measured aerodynamic diameter. Shown is the mean value at each size, together with the standard deviation in each measurement. Also shown is the expected relationship based on the particle refractive index and material density. For the polystyrene latex the optical vs aerodynamic size is nearly a one-to-one line. For this aerosol the optical and physical particle size are the same, as this particle type serves as the standard for optical sizing. The polystyrene latex material density (1.055 g/cm³) is close to one, and thus its physical and aerodynamic size are very similar. For borosilicate glass, the material density (2.55 g/cm³) is much larger than unity, while the refractive index is close to that of polystyrene latex. Theoretically the aerodynamic size is larger than the particle physical size, while the optical size is approximately the same as the physical diameter. FIG. 16 presents the theoretical line corresponding to its material density and refractive index for each of these aerosol types. On average the comparison of the optical and aerodynamic signals enables us to distinguish between these two types of particles. Recording this correlated optical and aerodynamic response is readily possible with binning devices such as a field programable gate array, wherein the binning parameters span a specific transit time and a specific optical response. Bin boundaries can be selected such that optical limits of a bin are scaled to its transit time limits, thus optimizing the range spanned by the array. With this approach particle counts can be readily accumulated in accordance with both aerodynamic and optical size.

Pulse shape is also significant for accurate measurement. When particle velocity is determined by the time-of-flight between two distinct points, such as in the work cited above, there is always the complication of pairing the signals from each point, and determining whether the signal from both are from the same particle. This can be complicated due to stray particles in the optics chamber that can occasionally wander across one of the beams, or across one of the crests in the crested beam. Using a single light beam for the time-of-flight determination eliminates the question of pairing signals from two points, but it still can be complicated by stray particles. Additionally, should a second particle enter the laser beam before the first one exits, the resulting is a broad peak that would appear as a single, slower moving (hence large) particle. These types of events—stray particles or coincidence—do not yield an accurate particle size, and need to be identified and excluded from the particle counts.

Analysis of the pulse shape in the aero-optical sizer disclosed herein can identify these confounders. The signals produced whenever a single particle passes through the light beam exhibit a consistent shape that is approximately Gaussian. This can be evaluated quantitatively by examining the observed peak width at two points, such as at 70% and at 50% of the peak height. For a Gaussian shaped pulse this ratio has constant value of 0.71, regardless of the height or standard deviation.

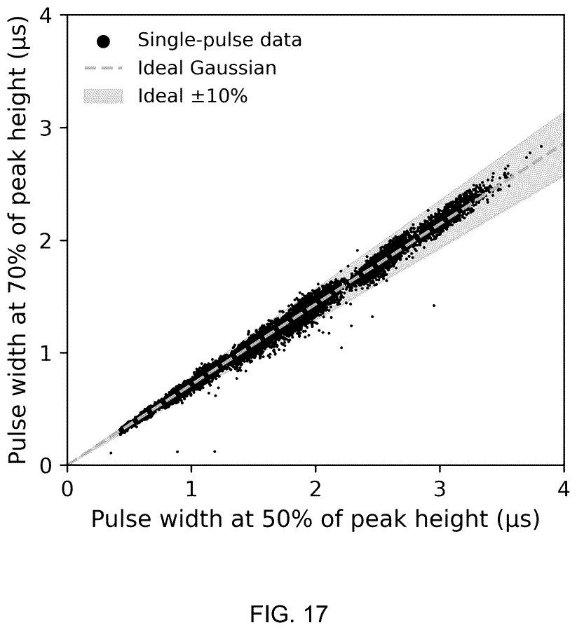

FIG. 17 is a graph of the light scattering pulse width at 70% of the peak maximum versus its width at 50% of the maximum. FIG. 17 shows this comparison for approximately 12,000 pulses collected over a range of particle sizes and flow rates. Plotted is the full peak width at 70% of the maxima versus that at 50% (which is FWHM). More than 99% of the points fall within 10% of the 0.71 line that indicates a Gaussian pulse. Those points below the line are characteristic of slow-moving particles that drifted across the beam, while coincident events can lead to peak width ratios that are either larger or smaller than the Gaussian value.

In summary, three characteristics can be captured from the light scattering signal from each individual particle passing through the detector disclosed herein, namely the transit time, the peak shape and the peak height. The peak shape is used to identify valid pulses. For valid pulses the transit time and optionally the peak height are recorded. In the testing presented here the data processing was done off-line. To process the data in real time, the recording is done by binning the data, such that counts are accumulated in bins in accordance with the measured particle transit time and optionally also by peak height. Such binning can be done with a field programmable gate array. From the counts binned by transit time the system can output an aerodynamic size distribution based on calibrations. With an assumed material density of the suspended particulate matter, the system can also output an estimated mass of suspended particulate matter over the size range measured by the instrument.

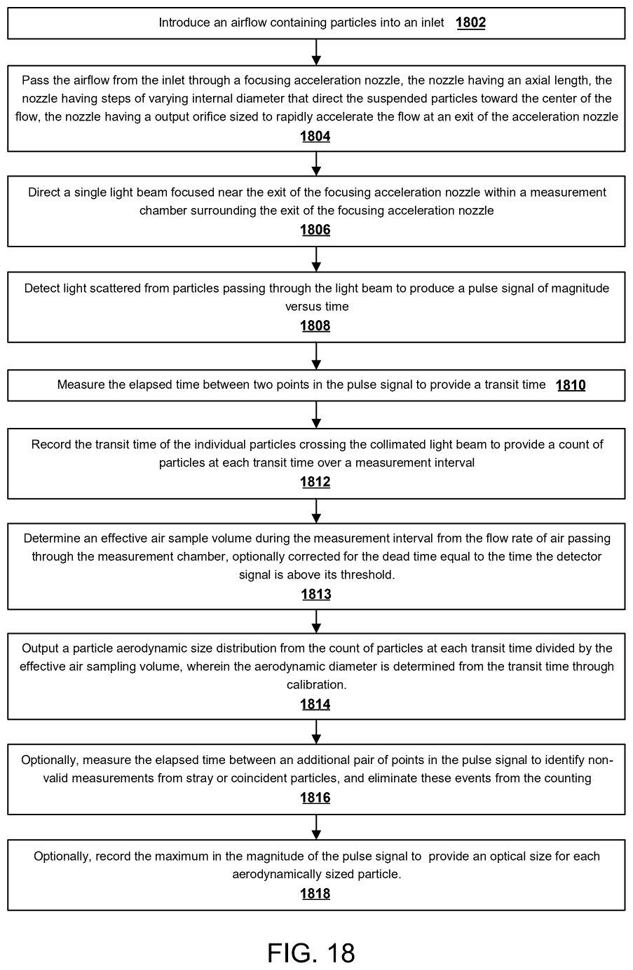

FIG. 18 is a flowchart illustrating a method in accordance with the present technology. In one embodiment, an airflow containing suspended particles is introduced into an inlet (step 1802). The airflow is generally at or near atmospheric pressure as it enters the system. From the inlet, the airflow is directed through a focusing acceleration nozzle (step 1804). The nozzle has an axial length and includes one or more internal steps or changes in diameter configured to progressively focus the suspended particles toward the central axis of the flow. The nozzle terminates in an output orifice that is sized to rapidly accelerate the airflow at the nozzle exit.

A single light beam is directed and focused near the exit of the acceleration nozzle (step 1806). A measurement chamber surrounds this region such that particles exiting the nozzle pass through the collimated light beam. As each particle intersects the beam, the system detects light scattered from the particle, thereby producing a pulse signal having a magnitude that varies over time (step 1808).

The system measures the elapsed time between two predetermined points on the pulse signal to determine a transit time associated with each particle (step 1810). The transit time corresponds to the time required for an individual particle to traverse the width of the beam. Each measured transit time is recorded to generate a count of particles at each transit time over a defined measurement interval (step 1812).

In some embodiments, the system measures an additional elapsed time between another pair of points on the same pulse signal (step 1816). This supplementary timing measurement allows identification of invalid events, such as stray particles or coincident particles passing simultaneously through the measurement region. Such events are excluded from the final particle count.

The effective air sampling volume for the measurement interval is then determined from the volumetric flow rate through the measurement chamber, optionally corrected for detector dead time—the period during which the detector signal remains above a defined threshold and is unable to register additional particles (step 1813). The aerodynamic particle size distribution is subsequently obtained by dividing the count of particles at each transit time by the effective sampling volume. Transit time is converted to aerodynamic diameter based on calibration data (step 1814).

In optional embodiments, the system records the maximum magnitude of each pulse signal (step 1818). This maximum signal value corresponds to an optical size measurement for each individual particle and can be used in conjunction with the aerodynamic sizing data to characterize particle populations more fully.

The sequence of operations depicted in FIG. 18 provides a high-precision method for determining particle aerodynamic size distributions by combining controlled aerodynamic focusing, optical scattering detection, transit-time measurement, and calibrated conversion to aerodynamic diameter.

The disclosed technology provides measurement of the aerodynamic size of airborne particles at or near atmospheric pressure, while retaining optical scattering information. A focusing acceleration nozzle steers particles of the size range of interest along the central region of the flow, and subsequently rapidly accelerates the flow. A collimated light beam or laser is used to detect particles immediately downstream of the nozzle exit. The ratio of the particle inertia to its aerodynamic drag affects its velocity in the rapidly accelerating flow, such that aerodynamically larger particles lag the air stream velocity. Particle aerodynamic diameter is determined by the transit time across the light beam. Typically, this is characterized by the width of the light scattering pulse at one half of its maximum. Particle optical size is evaluated from the value of the light scattering pulse at its maximum, per calibration with polystyrene latex particles. The incidence of confounders due to stray or coincident particles is identified by analysis of the shape of the pulse, such as by the ratio of the peak width at two points such as 70% and 50% of the maximum.

Unique features, as compared to prior aerodynamic sizing methods at ambient pressures include, but are not limited to, the use of aerodynamic focusing in place of the sheath flow, the characterization of the particle velocity lag by the transit time across a single light beam, the simultaneous capture of optical signal and the identification of coincident or stray particle confounders through analysis of the pulse shape. The design of the aerodynamic focusing steps contrast from prior work in that the final nozzle is short and narrow so that the detection laser can be placed close to the point of maximum flow acceleration.

Further advantages of the disclosed technology include smaller size and lower cost of manufacture than known existing devices. These advances make feasible the monitoring of these coarse airborne particles in ambient air or indoor or industrial spaces.

For the purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For the purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

Although the present disclosure has been described with reference to specific features and embodiments thereof, various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations, or equivalents that fall within the scope of the present disclosure.

The present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims.

Furthermore, in the above detailed description of the present subject matter, numerous specific details are set forth to provide a thorough understanding of the present subject matter. However, persons of ordinary skill in the art will understand that the present subject matter may be practiced without such specific details.

Aspects of the present disclosure described herein with reference to flowchart illustrations and/or block diagrams of methods, apparatuses (systems) and computer program products according to embodiments of the disclosure. Some blocks of the flowchart illustrations and/or block diagrams, and combinations of blocks in the flowchart illustrations and/or block diagrams, can be implemented by computer program instructions.

The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I (We) claim:

1. A method for aerodynamic sizing of particles, comprising:
introducing an airflow containing particles into an inlet;
passing the airflow through a focusing acceleration nozzle, the nozzle having an axial length, the nozzle having a output orifice sized to rapidly accelerate the flow at an exit of the acceleration nozzle;
directing a single light beam focused near the exit of the focusing acceleration nozzle within a measurement chamber surrounding the exit of the focusing acceleration nozzle having;
detecting light scattered from individual particles passing through the collimated light beam to provide a pulse signal;
measuring the elapsed time between two points in the pulse signal to provide a transit time for each detected particle;
recording the transit time of individual particles crossing the light beam to provide a count of particles at each transit time over a measurement interval;
determining an effective air sample volume during the measurement interval from the flow rate of the airflow and the duration of the measurement interval; and
outputting a particle aerodynamic size distribution from the count of particles at each transit time divided by the effective air sampling volume, wherein the aerodynamic diameter is determined from the transit time through calibration.

2. The method of claim 1 wherein the focusing acceleration nozzle has one or more radial contractions along the axial length.

3. The method of claim 1 wherein the transit time is characterized by the full width at half maxima defined as the time between the point when the signal rises to one half of its maximum value until it drops to one half of its maximum value.

4. The method of claim 1 wherein the transit time is characterized by the time between the point when the signal attains its maximum until it drops to one half of its maximum value.

5. The method of claim 1 wherein the transit time is characterized by the time between the point when the signal reaches its maximum until it drops to a fixed fraction of its maximum value.

6. The method of claim 1 wherein the transit time is characterized by the time between the two fixed fractions of the maximum in the light scattering signal.

7. The method of claim 1 wherein the transit time is characterized by the time between the two fixed values in the magnitude of the light scattering signal.

8. The method of claim 1 further including recording a height of an individual light scattering pulse, the height defined as the maximum in the light scattering signal from an individual particle.

9. The method of claim 8 further including simultaneously measuring optical and aerodynamic size, and the simultaneous measurement of optical and aerodynamic size is used to distinguish among particle types.

10. The method of claim 8 further including calibrating the height of individual to an optical size of the particle.

11. The method of claim 10 further wherein the calibrating includes using polystyrene latex spheres to relate the height of individual to an optical size of the particle.

12. The method of claim 1 further including analyzing the shape of the pulse to identify erroneous signals that may arise from coincident or stray particles.

13. The method of claim 12 wherein the erroneous signals are excluded from the particle count.

14. The method of claim 1 wherein the mass of suspended coarse particulate matter over the measurement size range is estimated based on aerodynamic size distribution.

15. An apparatus for aerodynamic sizing of particles, comprising:
an inlet coupled to receive an airflow containing particles at or near atmospheric pressure;
a measurement chamber;
a focusing acceleration nozzle coupled to the inlet, the nozzle having an axial length, the nozzle having a output orifice sized to rapidly accelerate the flow at an exit of the acceleration nozzle into the measurement chamber;
a laser emitting a light beam focused at the exit of the focusing acceleration nozzle;
a detector detecting light scattered from particles passing through the collimated light beam to provide a pulse signal of magnitude versus time; and
a processor and memory, the processor including code instructing the processor to:
record a transit time of individual particles crossing the light beam; and
to output an aerodynamic diameter from the transit time based on calibration with particle standards of known size and density.

16. The apparatus of claim 15 wherein the focusing acceleration nozzle has one or more radial contractions along the axial length.

17. The apparatus of claim 15 wherein length of the final orifice is less than one half of the nozzle diameter.

18. The apparatus of claim 15 wherein distance between the nozzle exit and the collimated light beam is less than about 1 millimeter.
